(19) United States
(12) Patent Application Publication
(10) Pub. No.: US 2014/0168475 A1
(43) Pub. Date: Jun. 19, 2014

(54) FOUR-LENS SPHERICAL CAMERA ORIENTATION

(71) Applicant: MICROSOFT CORPORATION, Redmond, WA (US)

(72) Inventors: Joe Corkery, Burlingame, CA (US); James Burgess, Redwood City, CA (US); John Daniell Hebert, San Francisco, CA (US); Morgan Venable, San Francisco, CA (US); Benjamin Pelletier, Shadow Hills, CA (US)

(73) Assignee: Microsoft Corporation, Redmond, WA (US)

(21) Appl. No.: 13/715,196

(22) Filed: Dec. 14, 2012

(51) Int. Cl. G02B 13/06; H04N 9/64; G03B 5/00

(52) U.S. Cl. CPC G02B 13/06; G03B 5/00; H04N 9/646
USPC 348/239; 359/504; 396/529

(57) ABSTRACT

Panoramic and spherical cameras are often configured to capture respective portions of a scene using a set of lenses that focus images on imagers for sampling by photosensitive elements. In many such cameras, the orientation of the lenses is selected to resemble to a regular prismatic solid (e.g., one lens oriented according to a face of a cube). However, such lens orientations may create gaps between images that result in blind spots, and/or varying degrees of coverage overlap. Presented herein are techniques for orienting the lenses in an asymmetric manner, comprising one forward lens and three backward lenses having a 120-degree rotational angle around a first (e.g., front-to-back) axis and a variable inclination angle perpendicular to the first axis. This lens orientation may be selected (e.g., by a computer) to achieve a desired degree of coverage overlap while significantly reducing gaps that create blind spots in the composite image.

### BACKGROUND

Within the field of imaging, many scenarios involve a camera featuring a set of two or more fisheye lenses, each configured to focus an image on an imager comprising a portion of the viewing sphere around the camera, and where the images captured by the imagers in order to generate a composite image. In many such examples, the lenses are oriented at the centers and/or midpoints of a regular prismatic solid; e.g., for a cubical orientation, each fisheye lens may be crafted with a curvature that captures approximate 90 degrees of the scene, and four such lenses may be provided that are oriented to face outward from each square side of the camera, optionally including fifth and sixth lenses for the top and/or and bottom faces of the cube. At a desired moment, all of the imagers may be concurrently invoked to sample the images respectively focused by one of the lenses, and the images may be combined to form a cylindrical and/or spherical image, which may be presented to the user for viewing the scene around the camera.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The orientations of the lenses within a spherical camera may vary, e.g., in order to capture different portions of the scene. However, because the images captured by respective lenses are often circular, different lens orientations may alter the geometry of the captured images, and may create various properties that may affect the operation of the camera. As a first example, two or more images may overlap in coverage to various extents. The camera may endeavor to register the images (e.g., identifying the coverage overlap portions in each image) while generating the composite images in order to reduce the appearance of seams. It may be appreciated that increasing coverage overlap, particularly with high-resolution images, may involve greater computational power to register the images. Alternatively, the lenses may be rigidly affixed in a highly precise orientation, such that the camera may use preset values while combining the images into the composite image. However, such precision may be difficult to achieve, and may be disrupted by a physical jolt. As a second example, gaps in the scene between two or more images may lead to blind spots in the image. Moreover, for a particular orientation, a first fisheye lens set having a deeper curvature (where each fisheye lens captures a greater arc of the scene) may diminish blind spots while exacerbating coverage overlap, while a second set of lenses having a shallower curvature may diminish coverage overlap while exacerbating blind spots. Many lens orientations may be considered while evaluating the tradeoff between reducing blind spots and selecting a desired coverage overlap among the images generated by the fisheye lenses.

Presented herein are techniques for orienting the lenses of a four-lens fisheye camera in a manner that may both reduce blind spots and achieve a desirable coverage overlap. Rather than orienting the lenses according to the faces of a regular prismatic solid, the presented techniques involve an asymmetric orientation. Along a first axis (e.g., a front-to-back axis within the camera), a first lens may be oriented facing forward, and the other three lenses may be oriented backward, with a rotational angle around the first axis that is approximately 120 degrees between any two backward lenses. Moreover, the backward lenses may be oriented with an inclination angle with respect to the first axis (e.g., each backward-facing lens may be rotated outward from the first axis, according to the inclination angle). The inclination angle, in particular, may be selected in view of the particular fisheye lenses selected for the camera, and in order to achieve a desired coverage overlap and a reduction of blind spots. In this manner, the orientation of the fisheye lens set may provide advantageous coverage of the scene, optionally enabling a reduction of seams, a higher image quality, and a more efficient and fault-tolerant alignment of lenses within the camera, in accordance with the techniques presented herein.

### DESCRIPTION OF THE DRAWINGS

FIG. 1 is an illustration of an exemplary scenario featuring the generation of a spherical image composited from a set of images captured by respective fisheye lenses.

FIG. 2 is an illustration of two alignments of fisheye lenses within a spherical camera that exhibit varying degrees of coverage overlap and blind spots.

FIG. 3 is an illustration of an exemplary orientation of lenses in a fisheye lens set in order to generate a composite image for a spherical camera in accordance with the techniques presented herein.

FIG. 4 is an illustration of a density map of an exemplary spherical lens set oriented according to the techniques presented herein.

FIG. 5 is an illustration of an exemplary spherical camera featuring a fisheye lens set comprising four lenses oriented according to the techniques presented herein.

FIG. 6 is an illustration of an exemplary method of oriented a four-lens fisheye lens set of a camera according to the techniques presented herein.

FIG. 7 is an illustration of an exemplary scenario featuring a variable inclination angle for sets of fisheye lenses having various curvatures.

FIG. 8 presents an illustration of an exemplary computing environment wherein the techniques presented herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A. Introduction

Within the field of imaging, many scenarios involve a spherical camera comprising a set of fisheye lenses and configured to generate a composite image aggregating the images provided by the lenses. The camera may be configured to generate a spherical image, comprising a compositing of images concurrently captured by a set of curved lenses, and focused upon one or more imagers respectively configured to sample the focused image(s) via photosensitive elements and generate one or more digital images. For example, digital cameras often include a charge-coupled device (CCD) or complementary metal-oxide-semiconductor (CMOS) image sensor, where the image is focused on a two-dimensional planar array of photosensitive elements that generate a two-dimensional array of pixels comprising the image. These digital images may be aggregated into an image representing the view partially or completely wrapping around the viewpoint at the time that the images were captured by the imager(s).

In such scenarios, the orientation of respective fisheye lenses may be selected in many ways. Frequently, the lenses are oriented in a regular prismatic manner, e.g., facing outward from the center of respective faces of a cube (optionally including the top and bottom of the cube). Each lens may be configured to capture an approximately 90-degree curved portion of the view. The images captured by the fisheye lenses may be composited according to the regular prismatic orientation of each fisheye lens, thus providing a comparatively simple compositing technique.

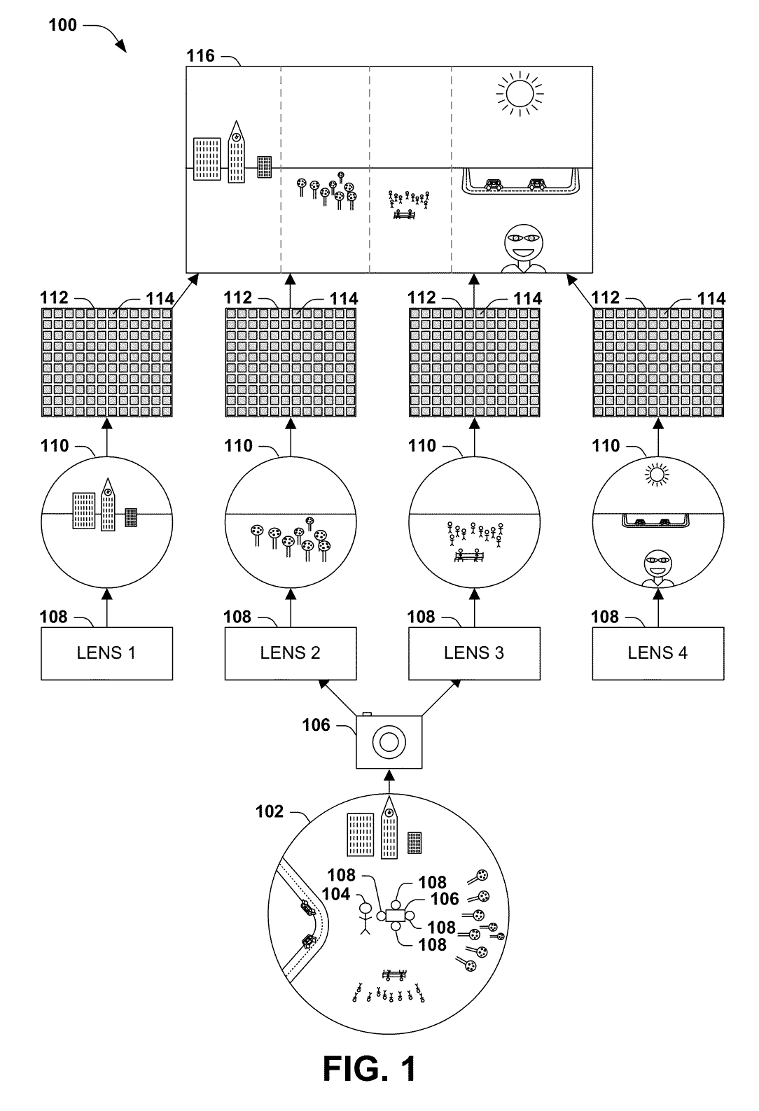

FIG. 1 presents an illustration of an exemplary scenario 100 featuring a camera 106 operated by a user 104 to generate a spherical image of a scene 102, such as the environment around the user 104. In this exemplary scenario 100, the camera 106 comprises four lenses 108 oriented to face in each cardinal direction with respect to the camera 106 (e.g., a first lens 108 facing forward; a second lens 108 facing backward; and two additional lenses 108 facing left and right), each configured to capture an approximately 90-degree view of the scene 102. Each image 110 captured by a lens 108 may be focused upon an imager 112 comprising an array of photosensitive elements 114, each configured to sample a small portion of the image 110 and output a light reading as a pixel. The samplings recorded by the imagers 112 may then be combined to produce a composite image 116 featuring the viewing sphere around the user 104, often including the user 104 holding the camera 106. (While the composite image 116 is illustrated herein as a flattened image for simplicity, it may be appreciated that the composite image 116 may also be cylindrical and/or spherical, and may be presented in a user interface that enables the user to look around within the composite image 116.)

In these and other scenarios, the selection and orientation of the respective lenses 108 may be selected as various configurations, and each configuration may affect particular properties of the composited image 116. As a first example, the curvature of the respective lenses 108 may alter the spherical coverage of the lens 108; e.g., a more highly curved lens 108 may cover a large viewing angle within the scene 102, while a less highly curved lens 108 may cover a smaller viewing angle within the scene 102. As a third example, the orientations of two lenses 108 may result in tangential coverage of the scene 102; may result in a coverage overlap within the scene 102 (e.g., a portion of the scene 102 that is captured in the images 110 generated by both lenses 108); or a gap within the scene 102 that is not included in the image 110 captured by either lens 108, and thus creates a blind spot in the composite image 116. As a third example, the configuration of the lenses 108 and/or the quality of the imagers 112 may result in a variable resolution across the image 110; e.g., a highly curved lens 108 may result in a significant spherical aberration that reduces the resolution and/or quality near the edge of the image 108. These and other properties of the lenses 108 and/or imagers 112 may affect the selection of the orientation of the lenses 108 of the fisheye lens set of a spherical camera 106.

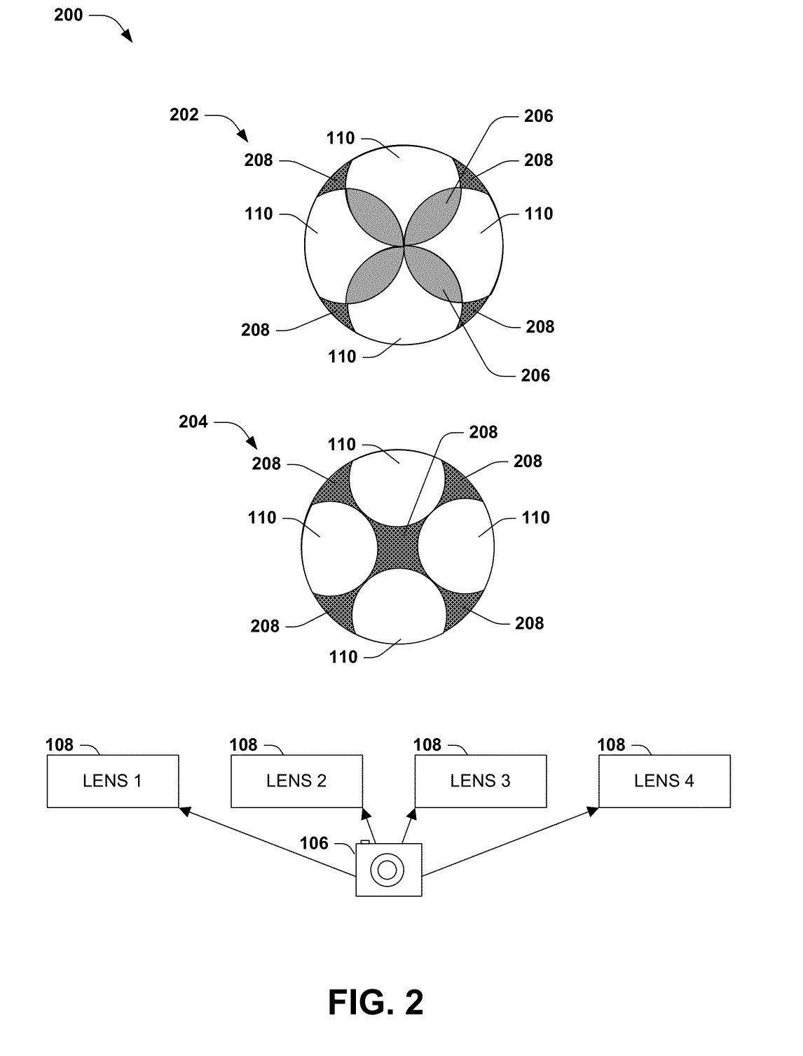

FIG. 2 presents an illustration of an exemplary scenario 200 featuring a camera 106 having four lenses 108 oriented in the regular prismatic manner illustrated in the exemplary scenario 100 of FIG. 1, and two optional orientations of the lenses 108 that may result in various types of coverage of the scene 102. The first example 202 and second example 204 each illustrate which portions of the view 102 are covered by the images 110 generated from lenses 108 in two different configurations and orientations. As a first example 202, if the lenses 108 are highly curved and cover more than a 90-degree view of the scene, then the images 110 from respective lenses 108 may include a significant amount of coverage overlap 206 (e.g., the football-shaped coverage overlap 206 appearing between the top image 110 and the right image 10 in the first example 202). Additionally, between the edges of the images 110, gaps 208 may appear that result in blind spots in the composite image 116. By contrast, in a second example 204, a different selection and orientation of lenses 108 (e.g., lenses 108 having a lower magnitude of curvature) may diminish or eliminate the coverage overlap 206, but may result in significantly larger gaps 208 in the field of view.

In addition to these problems, other problems may result from the selection and orientation of the lenses 108 that affect the image quality of the composite image 116. As a first example, the image quality at the edges of respective images 110 may be lower than the image quality near the center of the image 110. For example, and in particular for highly curved lenses 108, the curvature of the lens 108 may create a significant spherical aberration nearer the edges of the lens 108 and the image 110 that, even with correction, is not as clear or as high-resolution as the portion of the image 110 captured by the (comparatively flat) center of the lens 108. This may be partially alleviated by creating a coverage overlap 206, such that the edge of a first image 110 captured by a first lens 108 is also captured in a second image 110 captured by a second lens 108. The corresponding overlapping portions may be averaged in order to produce a more accurate image capturing in these regions of coverage overlap 206. However, it may further be appreciated that detecting the extent of the coverage overlap 206 may involve a computational process (e.g., an image registration technique) that attempts to align the overlapping portions of respective images. It may be further appreciated that an increasing size of the coverage overlap 206 between two lenses 108 may involve a proportionally increasing amount of computational power, which may consume more portable battery power, utilize a higher-throughput processor, and/or take more time to process than an orientation producing a lower coverage overlap 206. Alternatively, a coverage overlap 206 between two lenses 108 may be resolved simply by discarding a portion of the image 110 focused by one lens 108, but this technique creates inefficiency in the non-use of provided resources. As a second example, an orientation may be selected to produce a small or nonexistent coverage overlap 206 between two or more lenses 108. However, in order to avoid creating a gap 208, the lenses 108 may be have to be precisely aligned and rigidly fixed in place, due to the significant consequences in alignment due to small movements of the lenses 108. This alignment may also be disturbed, e.g., by a small shock, thus creating misalignment of the images 110 until the precise orientation of the lenses 108 is restored. As a third example, some of the gaps 208 in the coverage of the view represent are rather difficult to reach; e.g., in order to reach the peripheral gaps 208 in the first example 202 or the center of the middle gap 208 in the second example 204, the images 110 have to be very considerably expanded, and much of the image expansion creates undesirably large increases in coverage overlap 206. For at least these reasons, it may be appreciated that the selection and orientation of the lenses 108 of the fisheye lens set may significantly affect the coverage and quality of the composite image 116 generated therefrom.

B. Presented Techniques

The techniques presented herein enable an alternative orientation for the lenses 108 of a fisheye lens set than the regular prismatic orientations presented in the exemplary scenarios of FIGS. 1 and 2. In the orientation techniques presented herein, the fisheye lens set comprises four lenses 108, which are positioned in the following manner. A first axis may be selected, such as a front-to-back axis within the camera 106, and a first lens 108 may be oriented face forward along this axis. However, the other three lenses 108 are oriented facing comparatively backward along this axis. The three backward lenses may also be oriented with an approximately 120-degree rotational angle between the lenses 108 (e.g., when viewed from the rear, each lens 108 of the lens set is oriented at an approximately 120-degree angle with respect to each of the other two backward lenses). Additionally, the three backward lenses may be angled upward and/or outward according to an inclination angle. For example, a first backward lens that is oriented upward with respect to the other two lenses may be angled upward at a particular inclination angle with respect to the first axis, and the other two backward lenses (oriented toward the bottom-left and bottom-right may also be angles outward at a particular inclination angle with respect to the first axis. This adjustment may be selected, e.g., in view of the properties of the lenses 108 (e.g., the degree of curvature), and may be adjusted to provide an acceptable amount of coverage overlap 206 while reducing the gaps 208 between the images 110 captured thereby.

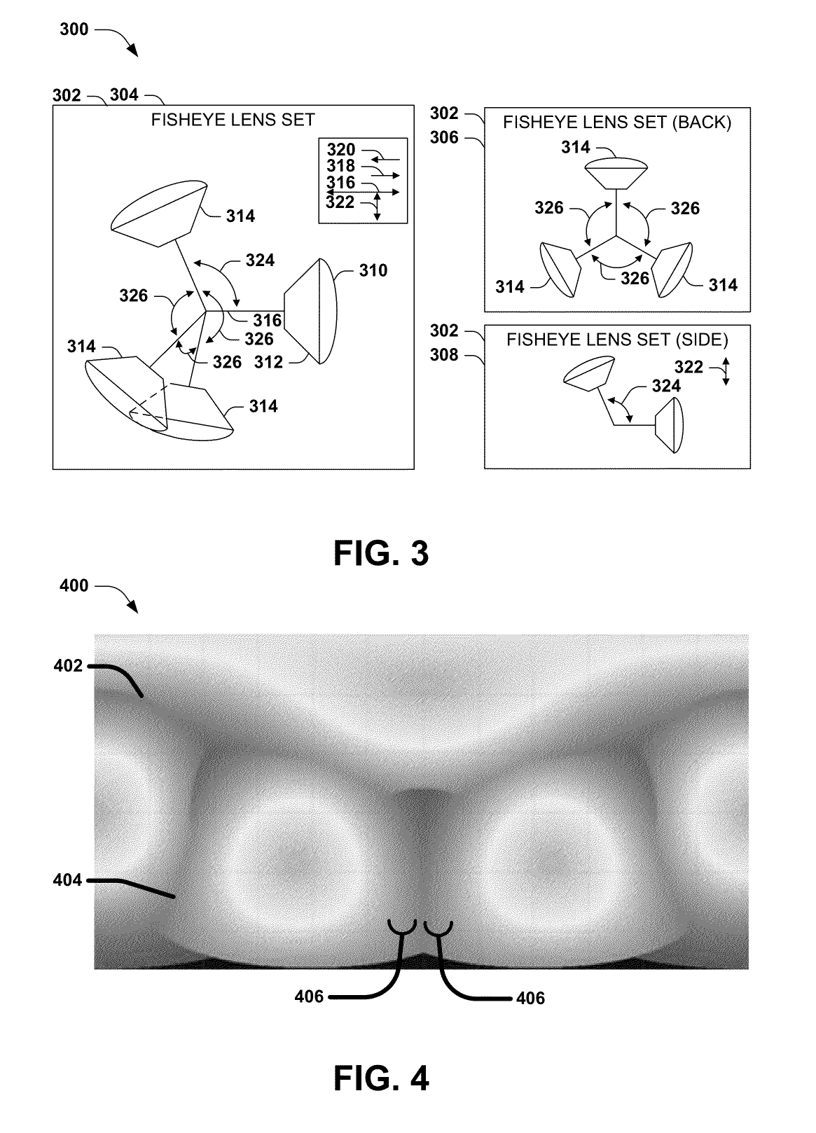

FIG. 3 presents an illustration of an exemplary scenario 300 featuring a fisheye lens set 302 oriented in accordance with the techniques presented herein. This exemplary scenario 300 presents three views of the fisheye lens set 302, illustrated as a slightly isometric view 304 and a back view 306 of the fisheye lens set 302, and a side view 308 of two of the lenses 108 of the fisheye lens set 302. In the slightly isometric view 304, the fisheye lens set 302 comprises four lenses 108 respectively oriented along a first axis 316 (e.g., running left-to-right) and a second axis 322 that is orthogonal to the first axis 316 (e.g., running top-to-bottom). Respective lenses 108 also comprise a curvature 310 having a magnitude and shape that determine the arc of coverage of the image 110 within the scene 102 created by the lens 108. With respect to these axes, the fisheye lens set 302 includes a forward lens 312 that is oriented in a first direction 318 along the first axis 316 (e.g., a forward direction), and three backward lenses 314 facing in a second direction 320 that is opposite the first direction 318 along the first axis 316 (e.g., a backward direction). The backward lenses 314 are oriented with a rotational angle 326 around the first axis 316 (e.g., an approximately 120-degree angle between any two backward lenses 314), as may be apparent from the back view 306. Moreover, while maintaining the approximately 120-degree rotational angle 326 among the backward lenses 314, the rotational angles of the lenses 314 may be selected with respect to the second axis 322 (e.g., to provide one upward-facing backward lens 314 and two downward-facing backward lenses 314 as shown in the exemplary scenario 300 of FIG. 3, or with various other adjustments of the entire set of backward lenses 314). Additionally, the backward lenses 314 are oriented with an inclination angle 324 providing an angle of inclination from the first axis 316 to the second axis 322. For example, the upward-facing backward lens 314 may be angled upward toward the second axis 322 at a variable inclination degree 324 (e.g., as may be apparent from the side view 308). Additionally, the lower-facing backward lenses 314 may be angles downward and/or outward at the inclination angle 324 with respect to the first axis 316. In this manner, the three backward lenses 314 may present a variable orientation (particularly in the inclination angle 324) in order to achieve an orientation providing advantageous coverage of the scene 102 (e.g., a desirable amount of coverage overlap 206 and a reduction or elimination of gaps 208).

This lens orientation may present several advantages over other lens orientations (particularly regular prismatic lens orientations). As a first example, this orientation provides more even spacing of the lenses 108 over a spherical view than other orientations, such that expanding coverage of the images 108 (e.g., by selecting fisheye lenses 108 of greater curvature) may more evenly fill coverage gaps 208 while providing only modest increases in coverage overlap 206. That is, this lens orientation creates fewer “hard-to-reach” gaps than other orientations, particularly regular prismatic orientations.

As a second exemplary advantage, this orientation provides an approximately uniform geometry between any lens 108 and each other lens 108. If the same lens type is used for all four lenses 108, approximately equal coverage overlap 206 is created between any lens 108 and the other three lenses 108. This type of symmetry is not achieved by regular prismatic orientations; e.g., in the exemplary scenario 200 of FIG. 2, an equivalent coverage overlap 206 is created between the images 110 created by any selected lens 108 and each of the two adjacent lenses 108, but a different coverage overlap 206 is created with the image 110 created by the fourth lens 108 that is opposite the selected lens 108.

As a third exemplary advantage, this orientation utilizes a smaller number of lenses 108 (respectively covering a larger arc of the view) than other orientations that utilize a larger number of lenses 108 (respectively covering a smaller arc of the view). This factor may be significant because the angular resolution across a larger image 110 is more consistent than the angular resolution arising at a seam between two images 110. By reducing the number of seams between images 110, this orientation provides a smoother overall angular resolution gradient over the view, resulting in a higher-quality composite image 116.

As a fourth exemplary advantage, the coverage of the scene 102 using a smaller number of lenses 108 and imagers 112 reduces the expense and increases the efficiency of the camera 106 with respect to those utilizing a greater number of lenses 108 and imagers 112 (e.g., registering and compositing four images 110 generated by four lenses 108 is likely to be more computationally efficient than registering six images 110 generated by six lenses 108).

As a fifth exemplary advantage, choosing the orientation of each lens 108 in this fisheye lens set 302 may be simpler, and may not depend on an extremely high level of precision as in other orientations of fisheye lens sets 302. For example, if the lenses 108 are positioned with a desired degree of coverage overlap 206, then small deviations in lens orientation (e.g., misalignment due to physical displacement) may be compensated during image registration of the overlapping image portions, rather than failing to capture a portion of the image between two lenses 108 and creating a blind spot 206 in the composite image 116. This flexibility may enable a faster and less precise lens alignment to capture the composite image 116.

Some of these potential advantages may be appreciated in view of FIG. 4, which presents an illustration of a density map 400 of an exemplary fisheye lens set 302 having the lenses positioned according to the techniques presented herein. It may be appreciated that due to the curvature of a fisheye lens 108, the amount of information transmitted for respective portions of the image 110 varies due to the surface area and curvature of the lens 108 capturing light for that portion of the image 110. Accordingly, the pixel density through the fisheye lenses 108 varies due to the concentration and/or dispersal of light received through that portion of the curved lens 108. For a particular fisheye lens set 302, FIG. 4 illustrates a density map 400 indicating the pixel density (e.g., amount of detail) generated across the lenses 108 (illustrated as a gradient from white to black representing high pixel density to low pixel density). In view of this density map 400, it may be appreciated that the orientation of the lenses 108 presented herein may enable several advantageous properties. As a first example, the junction of the images 110 focused by respective lenses 108 (both a first adjoining edge 402 between the forward lens 312 and respective backward lenses 314, and a second adjoining edge 404 between respective backward lenses 314) are comparatively well-adapted, thus reducing both coverage overlap 206 and gaps 208 that may create blind spots. As a second example, the alignment of respective edges causes a comparatively smooth transition 406 between the image 110 captured by a first lens 108 and the image 110 captured by a second lens 108, thus reducing the appearance of linear seams in the composite image 116 created by large changes in the pixel density at the junctions of respective images 110. These and other advantages may be achievable through the selection and orientation of lenses 108 for a spherical camera 106 according to the techniques presented herein.

C. Exemplary Embodiments

The techniques presented herein may be embodied in many types of embodiments.

A first exemplary embodiment is provided in FIG. 3, illustrated as an exemplary fisheye lens set 302 for a spherical camera 106. The fisheye lens set 302 comprises a forward lens 312 oriented in a first direction 318 along a first axis 316. The fisheye lens set 302 also comprises three backward lenses 314, respectively oriented with a second direction 320 along the first axis 316 that is opposite the first direction 318 (e.g., backward-facing lenses); a rotational angle 326 about the first axis 316 of approximately 120 degrees with the respective other backward lenses 314; and an inclination angle 324 from the first axis 316 to the second axis 322, where the inclination angle 324 is selected to create a coverage overlap 206 with the forward lens 312 that is approximately equal to the coverage overlap 206 of the backward lens 314 with respect to respective other backward lenses 314. The fisheye lens set 302 may be fixed in this orientation, e.g., using a rigid structure featuring slots or affixing points that, when coupled with lenses 108, orient the lenses 108 in accordance with the techniques presented herein.

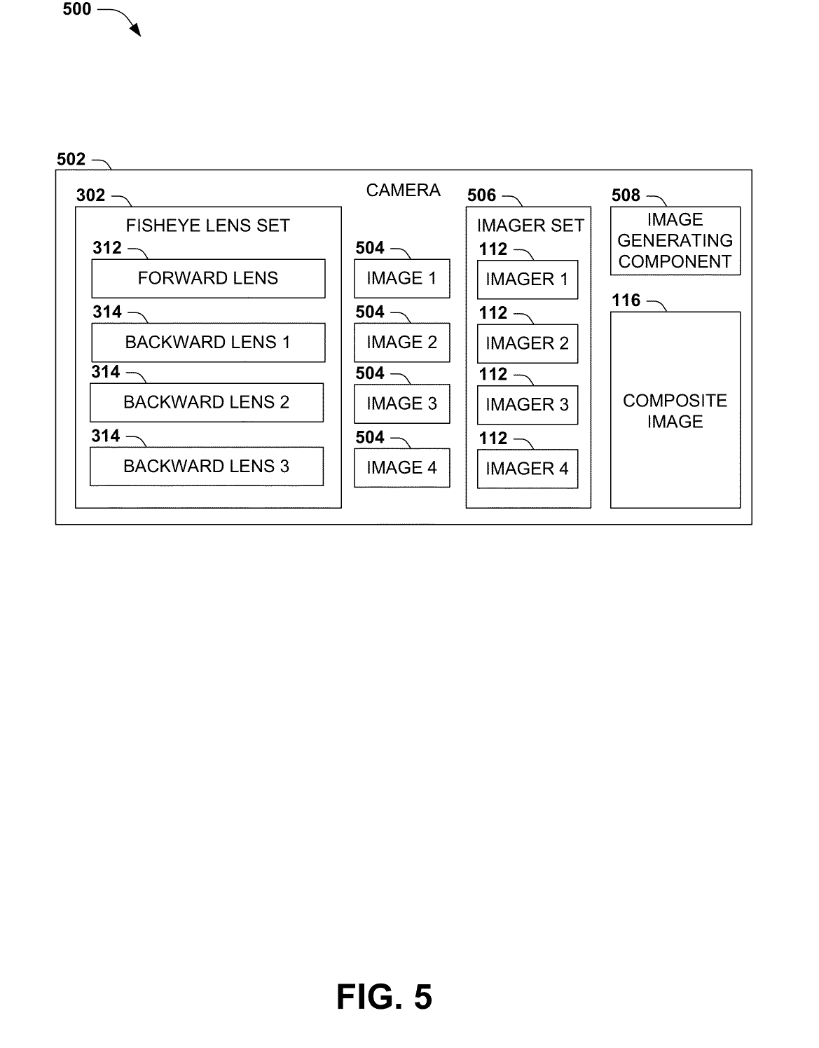

FIG. 5 presents a second exemplary embodiment of the techniques presented herein, illustrated as an exemplary scenario 500 featuring an exemplary spherical camera 402 comprising a fisheye lens set 302 as provided herein. In this exemplary scenario 400, the spherical camera 402 comprises a fisheye lens set 302, comprising a forward lens 302 that is oriented in a first direction 318 along a first axis 316. The fisheye lens set 302 also comprises three backward lenses 314, respectively oriented as provided herein: with respect to the first axis 316, oriented in a second direction 320 that is opposite the first direction 318; a rotational angle 326 about the first axis 316 of approximately 120 degrees with the respective other backward lenses 314; and an inclination angle 324, from the first axis 316 to the second axis 322, that is selected to create a coverage overlap 206 with the forward lens 312 that is approximately equal to the coverage overlap 206 of the backward lens 314 with respect to respective other backward lenses 314. The spherical camera 402 also comprises an imager set 406, comprising at least one imager 112 that is configured to receive an image 404 from a lens 108 of the fisheye lens set 302. The spherical camera 402 also comprises an image generating component 408, which is configured to generate a composite image 116 from the images 404 focused on the at least one imager 112. The image generating component 408 may comprise, e.g., a circuit applying a digital compositing process, or a set of instructions stored in a memory device of the spherical camera 402 (e.g., a memory circuit, a platter of a hard disk drive, a solid-state storage device, or a magnetic or optical disc) that, when executed on a processor of the spherical camera 402, cause the spherical camera 402 to generate the composite image 116 from the images 404 provided by the imager set 406. The spherical camera 402 therefore generates the composite image 116 of the scene 102 through the orientation of the lenses 108 of the fisheye lens set 302 in accordance with the techniques presented herein.

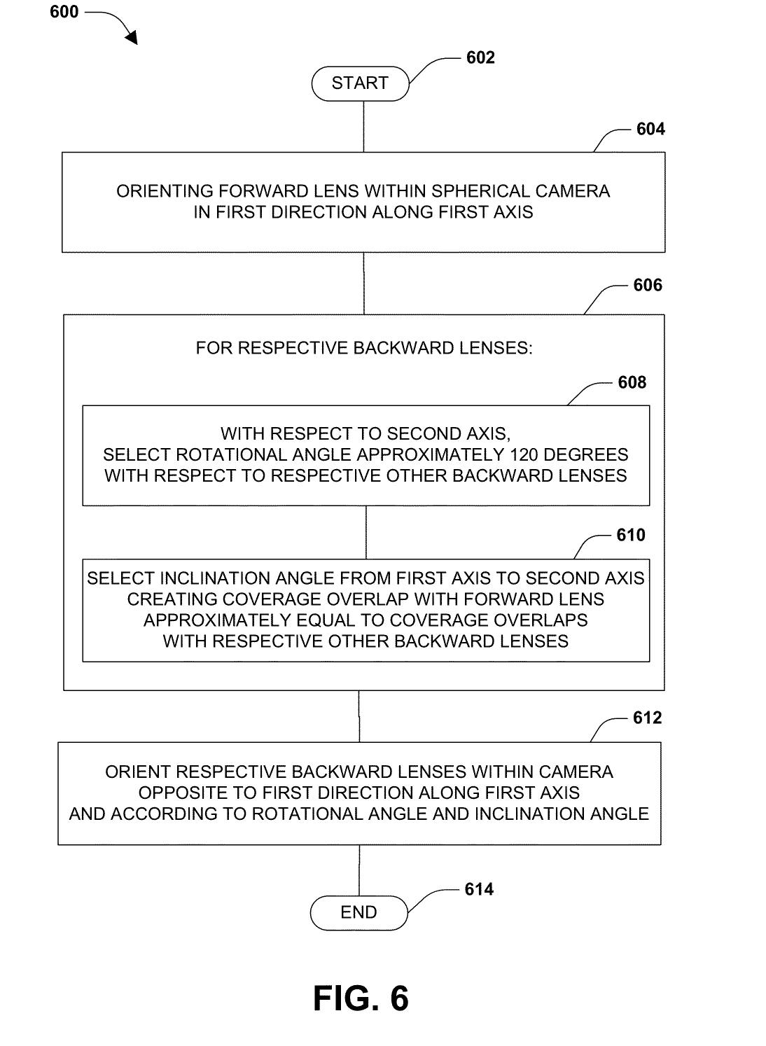

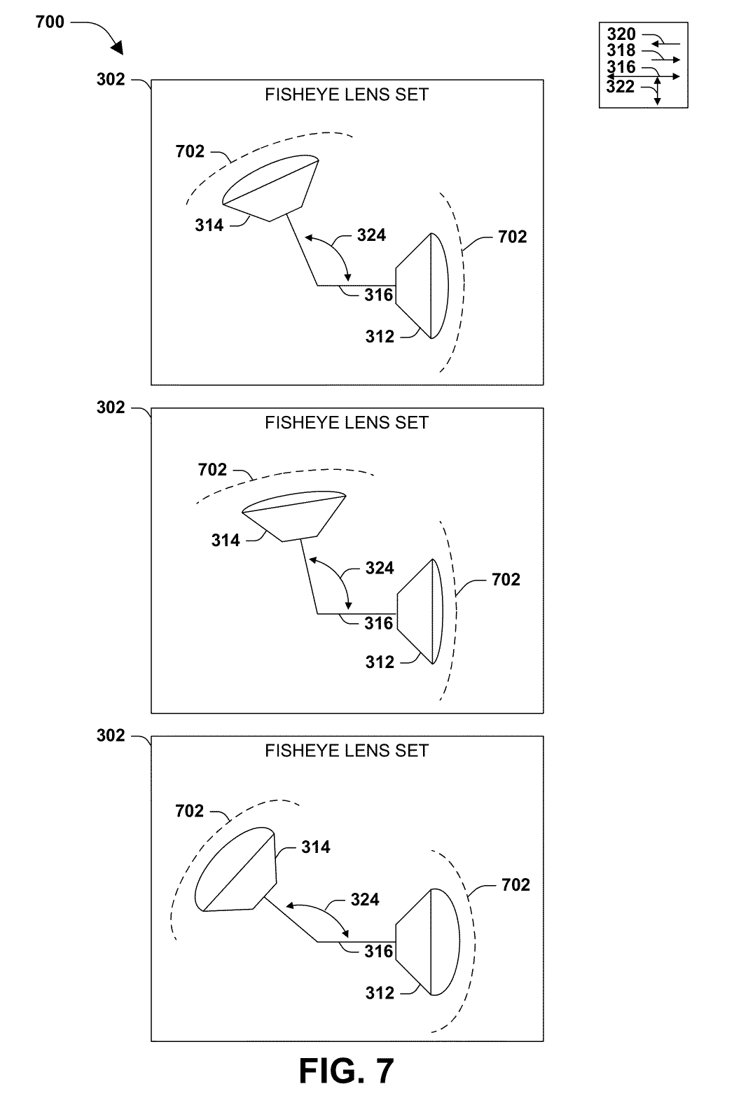

FIG. 6 presents a third exemplary embodiment of the techniques presented herein, illustrated as an exemplary method 600 of orienting, within a spherical camera 402, a fisheye lens set 302 comprising a forward lens 312 and three backward lenses 314. The exemplary method 600 begins at 602 and involves orienting 604 the forward lens 312 within the spherical camera 402 in a first direction 318 along a first axis 316. The exemplary method 600 also involves, for respective 606 backward lenses 312, selecting 608, with respect to a second axis 322 that is perpendicular to the first axis 316, a rotational angle 326 approximately equaling 120 degrees with respect to respective other backward lenses 314; and selecting 610 an inclination angle 324 from the first axis 316 to the second axis 322 that creates a coverage overlap 206 with the forward lens 312 that is approximately equal to the coverage overlap 206 of the backward lens 314 with the respective other backward lenses 314. The exemplary method 600 also involves orienting 612 respective backward lenses 314 within the spherical camera 402, in a second direction 320 along the first axis 316 that is opposite the first direction 318, and according to the rotational angle 326 and the inclination angle 324. In this manner, the exemplary method 600 achieves the orientation of the fisheye lens set 302 within the spherical camera 402 in accordance with the techniques presented herein, and so ends at 614.

D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments to confer individual and/or synergistic advantages upon such embodiments.

D1. Scenarios

A first aspect that may vary among embodiments of these techniques relates to the scenarios wherein such techniques may be utilized.

As a first variation of this first aspect, the techniques presented herein may be utilized with many types of spherical cameras 402. As a first such example, many classes of spherical cameras 402 may be utilized, such as analog or digital cameras; motion or still cameras; professional or amateur cameras; and standalone cameras or cameras implemented in another device, such as a computer or mobile phone. As a second such example, the spherical cameras 402 may be configured to capture various wavelengths of light, e.g., visible-light cameras capturing the visible spectrum; infrared cameras capturing the infrared portion of the spectrum; underwater cameras capturing the wavelengths of light that are typically visible underwater; and astronomical cameras capturing a broad swath of the electromagnetic spectrum. Conversely, the spherical cameras 402 may be configured to exclude some types of light; e.g., the spherical camera 402 may feature a polarized light source, and/or a polarizing filter that excludes wavelengths except along a particular polarity.

As a second variation of this first aspect, many types of imagers 112 may be utilized, such as charge coupled devices (CCDs) and complementary metal-oxide semiconductors (CMOSes). Additionally, the spherical camera 402 may feature a single imager 112 configured to receive multiple images 110 from the respective lenses 108, or multiple imagers 112 configured to receive a partial or complete image 110 from one or more lenses 108. The imagers 112 may also be provided in a set of cameras, arranged in a manner resulting in the orientation of the lenses 108 provided herein, where such cameras interoperate to generate the spherical composite image 116 according to the techniques presented herein.

As a third variation of this first aspect, the orientation of the lenses 108 may be secured through various types of structural elements. As a first example, the fisheye lens set 302 may comprise a rigid body that is configured to, when respective lenses 108 are inserted or affixed, rigidly orient the lenses 108 in the manner presented herein. As a second example, the lenses 108 of the fisheye lens set 302 may be adjustably oriented, and a user 104 may orient the lenses 108 in the manner provided herein. These and other types of cameras and lenses may be compatible with the techniques presented herein. Alternatively, an automated technique may be used to automatically select the variables of the orientation (e.g., the inclination angle 324) to achieve a desirable orientation and configuration of the lenses 108 and the camera 106. These and other scenarios may be compatible with the techniques presented herein.

D2. Lens Orientation

A second aspect that may vary among embodiments of these techniques relates to the manner of selecting the orientation of the lenses 108. It may be appreciated that while the lenses 108 oriented according to the techniques presented herein may involve some fixed aspects (e.g., the use of four lenses 108 with a forward-oriented lens and three backward-oriented lenses having a rotational angle of approximately 120 degrees), other aspects of the orientation may vary, and may be selected in view of other considerations.

As a first variation of this second aspect, the lenses 108 may be mounted with respect to the absolute orientation of the camera. As a first example, the first axis 316 of the fisheye lens set 302 may be selected as a forward-to-backward axis of the camera 106, such that the forward lens 312 captures a forward portion of the scene 102 (e.g., focusing on a person or object of interest of the scene 102 and positioned in front of the camera 106), while respective backward lenses 314 capture the area above, below, and behind the camera 106. As a second example, in a downward-facing camera (e.g., a camera on a boat positioned to capture images in the water), the first axis 316 of the fisheye lens set 302 may comprise a downward-to-upward axis of the camera 106. As a third example, in an upward-facing camera (e.g., an astronomic camera), the first axis 316 of the fisheye lens set 302 may comprise an upward-to-downward axis of the camera 106.

As a second variation of this second aspect, the orientation of the respective backward lenses 314 with respect to the second axis 322 may be selected in view of the orientation of the fisheye lens set 302 within the camera 106. It may be appreciated from FIG. 4 that the area density (and hence image quality) at and near the center of respective fisheye lenses 108 is often higher at and near the center of a lens 108 than at the edges. It may be further be appreciated from FIG. 4 that the positioning of the three backward lenses 314, with respect to the upward and backward portions of the composite image 116, may create three areas of marginally higher image quality (where the centers of respective backward lenses 314 are positioned) and three areas of marginally lower image quality (at each junction between two images 110). Accordingly, while the rotational angles 326 between respective backward lenses 314 is fixed, it may be appreciated that rotating the trio of backward lenses 314 together around the first axis 316 may result in subtle alterations in the image quality of respective portions of the composite image 116. For example, the first axis 316 of the fisheye lens set 302 may be oriented along the forward-to-backward axis within the camera 106. If the upward-facing portion of the composite image 116 is of higher interest than a downward-facing portion of the composite image 116, the rotation of the trio of backward lenses 314 may be selected such that one backward lens 314 faces upward and captures a marginally higher pixel density, and the other two backward lenses 314 create a downward-facing junction having a marginally lower pixel density.

As a third variation of this second aspect, the inclination angle 324 of the backward lenses 314 may be selected based on various factors. For example, choosing a larger inclination angle 324 results in a flatter and more backward-facing orientation of the backward lenses 314, while choosing a smaller inclination angle 324 results in a more upright orientation of the backward lenses 314. The inclination angle 324 and the curvatures 310 of the respective lenses 108 may alter the coverage overlap 206 and gaps 208 between each pair of backward lenses 314 and between respective backward lenses 314 and the forward lens 312, and, again, may subtly alter the image quality of respective portions of the composite image 116 (e.g., a more upright orientation results in marginally higher image quality in the upward-facing portions of the composite image 116, and a flatter orientation results in a marginally higher image quality in the backward-facing portions of the composite image 116). Thus, given a particular fisheye lens set 302, the inclination angle 324 may be selected to achieve a desirable tradeoff in these properties.

As a fourth variation of this second aspect, the lenses 108 to be included in the fisheye lens set 302 may be selected to achieve a desirable tradeoff in these properties. For example, given a particular inclination angle 324 of the fisheye lens set 302, different lenses 108 may be selected having different curvatures may alter the coverage overlap 206 and gaps 208 between the lenses 108. In some such variations, different lenses 108 having different curvatures 310 may be selected for inclusion in the fisheye lens set 302; e.g., the curvature 310 of the forward lens 312 may differ from the curvatures 110 of the backward lenses 314. Such mixed lens sets may lead to different profiles of coverage overlap 206 and gaps 208, and/or may alter the image quality of the composite image 116 (e.g., the forward lens 312 may be selected as more uniformly crafted than the backward lenses 314, thus providing a marginally higher image quality in the portion of the composite image 116 depicting a topic of interest in the scene 102 positioned in front of the camera 106 than the portions of the composite image 116 captured by the backward lenses 314).

These variable properties of the fisheye lens set 302 may be selected in view of various considerations. As a first example, the inclination angle 324 and/or curvatures 310 of the respective lenses 110 may be selected to reduce a blind spot between a first image 110 focused by a first lens 108 and a second image 110 focused by a second lens 108. As a second example, where respective first lenses 108 of the fisheye lens set 302 having a curvature 110 that, when the first lenses 108 are oriented within the spherical camera 106 with respect to respective second lenses 108 of the fisheye lens set 302, creates a coverage overlap 206 of a first image 110 focused by the first lens 108 and a second image 110 focused by the second lens 108, where the curvatures 110 of the respective lenses 108 are selected to create a coverage overlap 206 having a coverage overlap size exceeding a coverage overlap size threshold (e.g., a coverage overlap of a minimum size, providing for oversampling that my mitigate the marginally lower image quality provided near the edges of the lenses 108). As a third example, the inclination angle 324 from the first axis 316 to the second axis 322 may be selected to crate a coverage overlap 206 of respective backward lenses 314 with the forward lens 312 that is approximately equal to the coverage overlap of the backward lens 314 with the respective the other backward lenses 314 (e.g., creating an equivalent coverage gap 314 between each pair of lenses 108 in the fisheye lens set 302).

As a fifth variation of this second aspect, the inclination angle 324 and other properties may be automatically selected, e.g., by executing instructions on the processor that are configured to, for respective backward lenses 314, select the inclination angle 324 to achieve a desirable set of variables that is well-matched with the camera 106 and/or the scene 102. These and other variables in the orientation of the lenses 108 of the fisheye lens set 302, and the manner of selecting such variables, may be devised for use with the orientation of the fisheye lens set 302 in accordance with the techniques presented herein.

D3. Composite Image

A third aspect that may vary among embodiments of these techniques relates to the generation of the composite image 116 from the images 110 captured by the lenses 108 of the fisheye lens set 302. For example, the spherical camera 106 may further comprise at least one imager 112 configured to receive an image 110 from at least one lens 106 of the fisheye lens set, and the camera 106 may be configured to receiving the images 110 from the imagers 112 and generate a composite image 116 from the images 110, which the camera 106 may present to the user 104. More particularly, the camera 106 may generate the composite image 116 in various ways, based on the orientation of the lenses 108 within the camera 106. As a first example, the camera 106 may be programmed with and/or may automatically detect the inclination angle 324 and/or the rotational angles 326 of the lenses 108, and may register the images 110 with respect to one another using these angles. For example, for respective coverage overlaps 206 where a first portion of a first image 110 focused by a first lens 108 overlaps a second portion of a second image 110 focused by a second lens 108 of the fisheye lens set 302, the camera 106 may generate the composite image 116 from the images 110 by aligning the first portion of the first image 110 overlapping the second portion of the second image 110, and registering the first image 110 and the second image 110 according to the aligning (e.g., matching the overlapping area depicted in each image 110 to verify the registration). As a second example, for respective coverage overlaps 206, the overlapping areas focused by each lens 108 may be combined (e.g., as an arithmetic average), thereby providing additional sampling and higher image quality. This may be particularly advantageous for the portions of the images 110 near the edges of the lenses 108, where the image quality captured by the lens 108 is marginally lower. These and other features may be utilized to generate the composite image 108 in accordance with the techniques presented herein.

E. Computing Environment

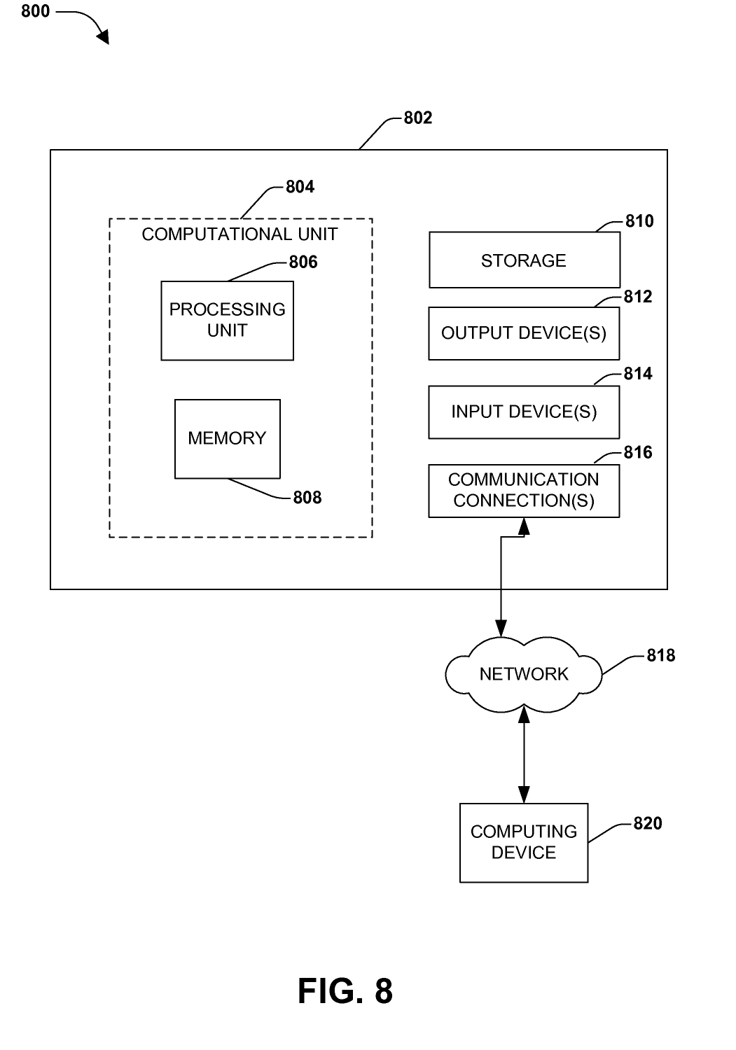

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one embodiment, computer readable instructions to implement one or more embodiments provided herein may be in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more embodiments provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A fisheye lens set for a spherical camera, comprising:
a forward lens oriented in a first direction along a first axis; and
three backward lenses respectively oriented with:
with respect to the first axis, a second direction that is opposite the first direction;
with respect to a second axis perpendicular to the first axis, a rotational angle about the first axis of approximately 120 degrees with respective other backward lenses; and
an inclination angle from the first axis to a second axis orthogonal with the first axis, the inclination angle selected to create a coverage overlap with the forward lens approximately equaling the coverage overlap of the backward lens with the respective other backward lenses.

2. The fisheye lens set of claim 1, the first axis of the fisheye lens set comprising a forward-to-backward axis of the spherical camera.

3. The fisheye lens set of claim 1, the rotational angles selected with respect to a rotational alignment with the second axis.

4. The fisheye lens set of claim 1:
respective first lenses of the fisheye lens set having a curvature that, when the first lenses are oriented within the spherical camera with respect to respective second lenses of the fisheye lens set, creates a coverage overlap of a first image focused by the first lens and a second image focused by the second lens; and
the curvatures of the respective lenses selected to create a coverage overlap having a coverage overlap size exceeding a coverage overlap size threshold.

5. The fisheye lens of claim 4, the curvatures of the respective lenses selected to reduce a blind spot between the first image focused by the first lens and the second image focused by the second lens.

6. A spherical camera, comprising:
a fisheye lens set comprising:
a forward lens oriented in a first direction along a first axis; and
three backward lenses respectively oriented with:
respect to the first axis, in a second direction that is opposite the first direction;
an inclination angle from the first axis to the second axis selected to create a coverage overlap with the forward lens that is approximately equal to the coverage overlap of the backward lens with respect to respective other backward lenses; and
with respect to a second axis perpendicular to the first axis, a rotational angle approximately equaling 120 degrees with the respective other backward lenses;
an imager set comprising at least one imager configured to receive an image from the fisheye lens set; and
an image generating component configured to generate a composite image from the images focused on the imager.

7. The spherical camera of claim 6, the first axis of the fisheye lens set comprising a forward-to-backward axis of the spherical camera.

8. The spherical camera of claim 6, the rotational angles selected with respect to a rotational alignment with the second axis.

9. The spherical camera of claim 6:
respective first lenses of the fisheye lens set having a curvature that, when the first lens is oriented within the spherical camera with respect to respective second lenses of the fisheye lens set, creates a coverage overlap of a first image focused by the first lens and a second image focused by the second lens; and
the curvatures of the respective lenses selected to create a coverage overlap having a coverage overlap portion size exceeding a coverage overlap size threshold.

10. The spherical camera of claim 9, the curvatures of the respective lenses selected to reduce a blind spot between the first image focused by the first lens and the second image focused by the second lens.

11. The spherical camera of claim 6:
a first portion of a first image focused by a first lens overlapping a second portion of a second image focused by a second lens of the fisheye lens set; and
the image generating component configured to generate the composite image from the images by:
aligning the first portion of the first image overlapping the second portion of the second image; and
registering the first image and the second image according to the aligning.

12. A method of orienting, within a spherical camera, a fisheye lens set comprising a forward lens and three backward lenses, the method comprising:
orienting the forward lens within the spherical camera in a first direction along a first axis;
for respective backward lenses:
with respect to a second axis that is perpendicular to the first axis, selecting a rotational angle approximately equaling 120 degrees with respect to respective other backward lenses; and
selecting an inclination angle from the first axis to the second axis creating a coverage overlap with the forward lens that is approximately equal to the coverage overlap of the backward lens with the respective other backward lenses; and
orienting respective backward lenses within the spherical camera, in a second direction along the first axis that is opposite the first direction and according to the rotational angle and the inclination angle.

13. The method of claim 12:
the method involving a device having a processor; and
selecting the inclination angle comprising: executing on the processor instructions configured to, for respective backward lenses, select the inclination angle from the first axis to the second axis creating a coverage overlap with the forward lens that is approximately equal to the coverage overlap of the backward lens with the respective other backward lenses.

14. The method of claim 12, the first axis of the fisheye lens set comprising a forward-to-backward axis of the spherical camera.

15. The method of claim 12, selecting the rotational angle further comprising:
for respective backward lenses, selecting the rotational angle with respect to a rotational alignment with the second axis.

16. The method of claim 12:
respective first lenses of the fisheye lens set having a curvature that, when the first lens is oriented within the spherical camera with respect to the forward lens and respective second lenses of the fisheye lens set, creates a coverage overlap of a first image focused by the first lens and a second image focused by the second lens; and
the method further comprising: selecting the respective lenses of the fisheye lens set respectively having a curvature that create a coverage overlap having a coverage overlap size exceeding a coverage overlap size threshold.

17. The method of claim 16:
the curvatures of respective lenses creating a field of view; and
the instructions further configured to, for respective first backward lenses, select the rotational angle and the inclination angle that, when the fisheye lens set is oriented within the spherical camera, creates a coverage overlap with respective second lenses that is approximately equal to the coverage overlap with respective third lenses.

18. The method of claim 16, selecting the respective lenses further comprising: selecting the curvatures of the respective lenses selected to reduce a blind spot between the first image focused by the first lens and the second image focused by the second lens.

19. The method of claim 12:
the spherical camera comprising at least one imager configured to receive an image from the fisheye lens set; and
the method further comprising:
receiving the images from the imagers; and
generating a composite image from the images.

20. The method of claim 19:
a first portion of a first image focused by a first lens overlapping a second portion of a second image focused by a second lens of the fisheye lens set; and
generating the composite image from the images comprising:
aligning the first portion of the first image overlapping the second portion of the second image; and
registering the first image and the second image according to the aligning.
